(19) United States
(12) Patent Application Publication
(10) Pub. No.: US 2016/0325444 A1
(43) Pub. Date: Nov. 10, 2016

(54) Method For Adjusting The Maximum Cooling Temperature of a Cooling Element of a User Electrical Appliance and User Electrical Appliance

(71) Applicant: Braun GmbH, Kronberg (DE)

(72) Inventors: Jan Christian Langsdorf, Oberursel (DE); Gerd Laschinski, Oberursel (DE); Christian Wachter, Ober-Ramstadt (DE)

(21) Appl. No.: 15/145,906

(22) Filed: May 4, 2016

(30) Foreign Application Priority Data
May 8, 2015 (EP) 15166943.9

(51) Int. Cl. B26B 19/48; B26B 19/38; F25B 21/04

(52) U.S. Cl. CPC B26B 19/48; F25B 21/04; B26B 19/382; B26B 19/3873

(57) ABSTRACT

A method and a user electrical appliance for adjusting the maximum cooling temperature of a cooling element of the user electrical appliance are described, wherein the cooling element is coming in contact with the users skin during regular use of the electrical appliance and wherein the cooling element is connected to a thermo element having a cold side and a warm side, the cold side of the thermo element being in thermoconducting contact with the cooling element and the warm side of the thermo element being in thermoconducting contact with a heat reservoir element of the user electrical appliance. The method comprising the following steps:
(a) measuring the temperature (θ) of the heat reservoir element;
(b) determining whether the measured temperature (θ) is below a lower threshold (θ_{low});
(c) cooling the cooling element thereby heating the heat reservoir element if the measured temperature (θ) is below the lower threshold (θ_{low}).

### FIELD OF THE INVENTION

The invention relates to a method for adjusting the maximum cooling temperature of a cooling element of a user electrical appliance and a respective user electrical appliance, wherein the cooling element is coming in contact with the users skin during regular use of the electrical appliance and wherein the cooling element is connected with a thermo element having a cold side and a warm side. The cold side of the thermo element is in thermoconducting contact with the cooling element and the warm side of the thermo element is in thermoconducting contact with a heat reservoir element of the user electrical appliance. Preferably, the user electrical appliance can be a hair removal device, such as a razor or an epilator.

### BACKGROUND OF THE INVENTION

It is known to have razors with a cooling element for cooling the human skin during the shave. This is pleasant for the user and reduces skin irritations. The DE 1 143 128 B describes a cooling element based on a ventilator leading an airflow towards the skin. In the DE 10 2008 032 150 A1 a respective electrical razor is disclosed having a thermo element for cooling a cooling element in the smear head coming into contact with the user's skin during use.

### SUMMARY OF THE INVENTION

It is an object of the present invention to provide a method for adjusting the maximum cooling temperature of a cooling element of a user electrical appliance and a respective user electrical appliance to secure a maximum cooling temperature suited for contact with the human skin.

This object is achieved with the features of the independent claims. According to claim 1 it is provided to
(a) measuring the temperature of the heat reservoir element;
(b) determining whether the measured temperature is below a lower threshold;
(c) cooling the cooling element thereby heating the heat reservoir element if the measured temperature is below the lower threshold.

A respective user electrical appliance according to claim 9 has a microprocessor adapted to perform the above defined steps.

The cooling the cooling element is performed in line with the invention by an actuation of the thermo element with a DC voltage applied to the thermo element with the same polarity used during normal use of the user electrical appliance. This is advantageous because no reversing of polarity with respect to the thermo element is necessary. The thermo element is preferably a known peltier element. However, the thermo element can also be realized with any other element producing a temperature difference between one and the other side of the thermo element, e.g. using semiconductor elements.

In particular, the method is applied advantageously when the user electrical appliance is not in use.

The cooling of the cooling element can be performed for a determined actuation time before the cooling is stopped. In another, preferred embodiment a feedback control is realized by measuring the temperature of the heat reservoir element and comparing it with a target value. The cooling of the cooling element (and the respective heating of the heating element) is then continued until the target value of the temperature of the heat element is reached. The target value is preferably chosen above the lower threshold.

After the cooling of the cooling element and contemporaneous heating of the heat reservoir element, the method may be repeated with measuring the temperature of the heat reservoir element according to step (a). Before repeating the method, a predetermined pause can be implemented. The duration of the pause can be adapted to usual temperature changes in the environment of use of the user electrical appliance. In case of a hair removal device, such as a razor or epilator, the duration of a pause might vary between 1 to 6 hours, preferably.

By heating the heat reservoir element to a temperature above a lower threshold, a maximum cooling temperature, i.e. a minimum absolute temperature, is defined that is not underrun in the regular use of the user electrical appliance. Of course, during execution of the method in an idle mode of the user electrical appliance, by actuation of the thermo element even at temperatures of the heat reservoir element below the lower threshold, the temperature of the cooling element might drop below a desired temperature range. However, when stopping the actuation of the thermo element, the cooling element will very soon adapt the temperature of the environment and be then ready for a regular use.

The maximum cooling temperature in line with the invention is the minimum absolute temperature of the cooling element that can be obtained with the thermo element in the actuation condition, i.e. with the DC voltage and current provided in the circuit of the user electrical appliance for the actuation of the thermo element under regular working conditions. During actuation, the thermo element cools down the cold side of the thermo element and heats the warm side of the thermo element. The warmth is absorbed by the heat reservoir element. The cooling energy is cooling the cooling element.

The thermo element—actuated with the predefined actuation conditions—produces a defined temperature difference between its cold side and its warm side. Accordingly, the minimum absolute temperature (or maximum cooling temperature) of the cold side is defined by the temperature of the warm side. Accordingly, if the warm side of the peltier element is too cold, e.g. because the user electrical appliance is in a cold environment, the cooling element will have too low temperatures for coming into contact with human skin. If the temperature of the heat reservoir element (and accordingly of the warm side of the thermo element) is e.g. 5° C., the cooling element might have temperatures below 0° C. This might lead to damages of the human skin.

According to a preferred embodiment, the lower threshold might be set to the temperature of the dew point. This might be a suited lower temperature threshold as electrical appliances, such as razors or the like, are often used in humid environments in which condensed water inside the electrical appliance might occur at temperatures below the dew point. This might lead to technical defects. Further, the temperature of the dew point is a temperature that is already sensed as a “cool” temperature for human skin. In order to limit the cooling effect of the cooling element the dew temperature might be chosen thus as a suited lower threshold as the maximum cooling temperature obtainable with the thermo element is lying a certain temperature value under the threshold temperature. The dew point temperature can be determined through an additional humidity sensor integrated in the user electrical appliance.

Additionally to the check, whether the measured temperature of the heat reservoir element is below the lower threshold, it might useful in line with the method according to the invention to also determine whether the measured temperature is above a higher threshold. This step might in particular be performed after determining whether the measured temperature is below the lower threshold, if the measured temperature is not below the lower threshold. As the maximum cooling temperature reached by the cooling element using the thermo element is limited by the temperature of the heat reservoir element, the maximum cooling temperature reached by the regular use of the user electrical appliance might not be as cold as desired if the temperature of the heating element is too high when starting the regular use. The higher threshold will preferably set in accordance with the desired maximum cooling temperature of the cooling element to be reached during regular use of the electrical appliance. A desired maximum cooling temperature for a razor or epilator as preferred embodiment might be in the range between 0° C. to 20° C.

Continuing the before aspect of the invention, the method might also comprise the step of heating the cooling element, e.g. for a determined actuation time or until a target temperature is reached (feedback control), thereby cooling the heat reservoir element if the measured temperature is above the higher threshold. This can technically be performed e.g. by reversing the polarity of the DC voltage applied to the thermo element which is equivalent to a change of the direction of the electric current through the thermo element. In a preferred embodiment, the supply voltage/current to the thermo element is controlled directly by ports of a microprocessor. Then, the polarity of the ports might simply be reversed by a software control of the microprocessor. Else, a polarity change switch might be controlled and switched by the microprocessor to reverse the polarity of the DC voltage applied to the thermo element.

By tempering the heat reservoir element, the desired cooling temperature of the cooling element can be adjusted. The tempering might include in line with the invention both, heating or cooling of the heat reservoir element.

Another aspect of the invention proposes that the method might comprise, in particular before actuating the thermo element, the steps of checking whether the user electrical appliance was in regular use within a certain time period (of e.g. between 0.5 and 1 hour) before determining whether the measured temperature is above the higher threshold and waiting for a determined cooling pause before continuing with a subsequent method step if the user appliance was in use within said certain time period. In this certain time period, the heat reservoir element will presumably cool down to ambient temperature if the user electrical appliance is not used during this time period and the thermo element is not actuated by the proposed method during the determined cooling pause.

A suited duration of the cooling pause is for normal user electrical appliances, such as a razor or an epilator, between 30 and 90 minutes, preferably in the order of 1 hour. During the determined cooling pause, the proposed method is interrupted according to a preferred embodiment. Advantageously, upon expiring of the cooling pause, the method is continued with a subsequent measuring of the temperature of the heat reservoir element as subsequent step. Then the method might continue as described before.

The check whether a regular use occurred within said certain time period might be realized by a log-entry using the microcontroller. One possible way is that the microcontroller sets a flag with the actual time (that might comprise also the actual date) when the regular use of the user electrical appliance has finished. When the check for regular use is performed the time (and date, if provided or necessary) of the latest regular use can be determined and compared with the actual time (and date, of applicable) of checking. Another possibility is the use of a flag that is created upon starting or stopping the regular use and is deleted (e.g. by the microprocessor) after the certain time period has expired. In the case it is only necessary to check for the existence of this flag.

In case the actuation of the thermo element for both, cooling the cooling element and heating the cooling element, is performed for a determined actuation time, this determined actuation time for the heating or cooling of the cooling element can be the same time or a different time. The actuation times for heating, for cooling and/or both, heating and cooling, of the cooling element (with the counter reaction of heating the heat reservoir element) can be determined by a preset time duration implemented in the microprocessor. In a simple embodiment, the method might be repeated after the predetermined pause.

In a more advanced embodiment of the invention, the actuation time of the thermo element, for cooling and/or heating of the cooling element, can be determined by a measurement of the temperature of the heat reservoir element. In particular, it might be checked whether the temperature of the heating element is lower the then the lower temperature limit (while cooling the cooling element) or higher than the higher temperature limit (while heating the cooling element), and the actuation of the thermo element will continue until this condition is not met. The time until the one or the other condition is met is then the actuation time. In this case, the actuation time is determined dynamically. The determining of the actuation time is, in other words, a feedback control leading to an actuation time until the control variable meets the setpoint setting (feedback).

In particular before starting the proposed method, it might be additionally checked whether the user electrical appliance is in regular user operation, the method being then conducted only if no regular user operation of the user electrical appliance is detected. If regular user operation is detected, normal operation is performed including the cooling of the cooling element using the thermo element. Regular user operation might be detected if a motor of the user electrical appliance is running The check for regular operation might be performed before or directly after the check for the temperature of the heat reservoir element being below the lower threshold.

Further, in line with the invention it might be additionally checked, in particular in case of a user electrical appliance with secondary batteries (accumulators), whether the user electrical appliance is connected to the electric power system. If the battery-driven user electrical appliance is not attached to the electric power system, e.g. by inserting into a cradle or by inserting a charging cable into the electrical socket. This checking step should preferably be performed before any actuation of the thermo element during the proposed method (leading either to a heating or cooling of the heat reservoir element) thereby consuming a significant amount of electrical power.

The invention is also related to a user electrical appliance, in particular a hair removal device such as a razor or an epilator, having an electrical motor for driving an actuator of the user electrical appliance, the actuator being e.g. a hair removal tool such as a smear head or a pluck roll. Further, the electrical appliance comprises a power supply and a cooling element coming in contact with the user's skin during regular use of the electrical appliance. The cooling element itself comprises a thermo element having a cold side and a warm side, the cold side of the thermo element being in thermoconducting contact with the cooling element and the warm side of the thermo element being in thermoconducting contact with a heat reservoir element of the user electrical appliance. Further, a microprocessor adapted for controlling the actuation of the motor and the thermo element is provided. In line with the invention, the user electrical appliance comprises a temperature sensor in thermoconducting contact with the heat reservoir element and is connected to a measuring port of the microcontroller. Further, the microcontroller is adapted to perform the method as described before or parts thereof. The microcontroller can be any suited processor included in the user electrical appliance and adapted to perform all or any selection of the proposed method steps. The adaption of the processor can be achieved by implementing program code means in executable form on the processer such that when executed on the processor the proposed method or parts thereof are executed.

In a preferred embodiment, the power supply is built by secondary batteries and the user electrical appliance comprises a charging device for connecting the secondary batteries to the electric power system. The charging device might be a cradle or a charging cable. When the charging device is connected to the electric power system, the secondary batteries are charged. Further, an actuation of the thermo element in line with the proposed method for adjusting the maximum cooling temperature of the cooling element can then be performed with reducing the remaining electrical power in the batteries for a regular use of the user electrical appliance.

For a user electrical appliance being a hair removal device, such as a razor or an epilator, the cooling element can integrated into a smear head or pluck roller of the hair removal device. Thus, it is arranged close to the portion of skin treated by the appliance. It is further advantageous if the heat reservoir element is integrated in the casing of the hair removal device, the heat reservoir element building a least a part of the outer casing. This is suited for a good heat dissipation of the warmth created upon actuation of the thermo element.

In a preferred embodiment of the invention, the temperature sensor may be located in a position of the heat reservoir element where the heat reservoir element builds the outer casing. Such arrangement is reasonable as the measured temperature is close to the ambient temperature if the user electrical appliance is not used. After a regular use of the electrical user appliance, the heat reservoir element will soon adopt the ambient temperature due to the heat dissipation.

### BRIEF DESCRIPTION OF THE DRAWINGS

FIG. 1 shows schematically sectional view of a user electrical appliance according to a preferred embodiment of the invention.

FIG. 2 shows flow process chart of a method for adjusting the maximum cooling temperature of a cooling element of the user electrical appliance according to a preferred embodiment of the invention.

### DETAILED DESCRIPTION OF THE INVENTION

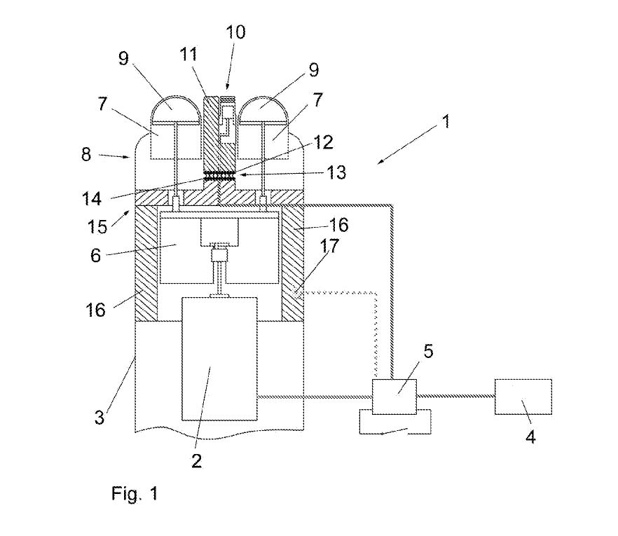

FIG. 1 shows a user electrical appliance 1 according to the present invention by means of an electrical razor as a preferred example for a user electrical appliance. Preferred embodiments of the invention are related to hair removal tools, such as razors or epilators. However, the inventions also relates to any user electrical appliance parts of which are provided for a direct contact with the user's skin. In the following, the terms “razor” and “user electrical appliance” are used as equivalents.

The razor as user electrical appliance 1 has motor 2 in a casing 3 of the razor 1. The motor 2 is powered by secondary batteries (not shown) that can be charge by a charger 4 under the control of a microprocessor 5. This means, that in the microprocessor 5 a program code was implemented that—when executed by the microprocessor 5—performs the necessary control steps. In this particular case, control steps for charging the secondary batteries. This is well known to the one skilled in the art and similar for all battery driven user electrical appliances.

The motor 2 is driving at least one actuator 6 for performing a certain action of the user electrical appliance 1. In case of the razor 1, the actuator 6 is actuating a smear element 7 (or as shown in FIG. 1 two smear elements 7) in the smear head 8 for cutting hairs of the beard with respective blades 9. This technique is well known, and there are different constructional possibilities for realizing the actuator 6 and the smear head 7. Additionally, the razor 1 according to the example of FIG. 1 comprises a further cutting element 10, which might be used as a longhair cutter. These cutting elements 10 are regularly also motor driven and of known technology. Therefore, these elements are not explained in detail in the context of the invention. The invention relates to all possible realizations of the smear heads 8 and/or cutting elements 10.

According to the invention, the user electrical appliance 1, i.e. the razor in the example shown in FIG. 1, comprises cooling element 11 disposed such in the electrical appliance 1 that it comes into contact with the user's skin during a regular use of the electrical appliance 1. For a razor, it is accordingly advantageous to dispose the cooling element 11 in the smear head 7 which is contacting the user's skin during cutting the hair of the beard. Depending on the type of the user electrical appliance, the one skilled in the art will dispose the cooling element in an advantageous position. The invention is not limited to a certain position of the cooling element 11 as long as it comes in direct contact with the skin of the user during a regular use.

The cooling element 11 is in thermoconducting contact with the cold side 12 of a thermo element 13 that cools down its cool side 12 when actuated. Normally, for actuation of the thermo element 13a respective voltage and current are applied to the thermo element 13. The thermo element 13 can be a peltier element well known in the art. When a current is flowing through the peltier element (or more generally the thermo element 13) it cools down its cold side 12 and contemporaneously heats its warm side 14.

With a certain voltage and current applied to the thermo element 13, the thermo element 13 produces a defined temperature difference between its cold side 12 and its warm side 14. As the cooling element 11 is in thermoconducting contact with the cold side 12 of the thermo element 13, cooling elements 11 adopts the temperature of the cold side 12 and is able to cool the user's skin when the skin comes in contact with the cooling element 11.

In order to conduct the warmth produced at the warm side 14 of the thermo element 13 away from the thermo element 13 and to avoid strong heating of the warm side 14 to very high temperatures (thereby reducing the maximum cooling temperature on the cold side 12) there is provided a heat reservoir element 15 in thermoconducting contact with the warm side of the thermo element 13. Accordingly, the heat reservoir element 15 absorbs the warmth and conducts it away from the warm side 15. To this aim, the heat reservoir element 15 is preferably of much higher mass than the warm side 14 of the thermo element 13. Accordingly, the warmth is distributed to a large corpus that is only slowly getting warmer. This is helpful as the regular time of use of the user electrical appliances 1, such as a razor or similar hair removal tool, is quite short. So, the heat reservoir element 15 is not heated very much.

Further, it is advantageous that parts 16 of the heat reservoir element 15 built a part of the outer casing of the user electrical appliance 1. Then the heat absorbed from the heat reservoir element 15 can easily be dissipated to the environment.

Both, the cooling element 11 and the heat reservoir element 15 are built of thermoconducting material, such as metal or thermoconducting plastic.

The microprocessor 5 is used to control the functions of the user electrical appliance 1. It switches on the motor 2 when the user turns on the appliances and applies a DC voltage and current to the thermo element. This is schematically shown in FIG. 1 by the one-line-connections between the microprocessor 5 and the motor 2 or the thermo element 13, respectively. However, a single line might comprise two conductor lines, as the one skilled in the art understands.

If the user electrical appliance 1 is located in a cold environment with temperatures e.g. about 5° C., the heat reservoir element 15 and the warm side 14 of the thermo element 13 will also adopt this low temperature. Due to the defined temperature difference between the warm side 14 and the cold side 12 of the thermo element 13 during actuation of the thermo element 13, the cold side 12 and the cooling element 11 might adopt temperatures below 0° C. This is, however, not desired as it is not comfortable for the user and might lead to irritations of the user's skin.

Therefore, the invention proposes a method for adjusting the maximum cooling temperature of the cooling element 11. This method is executed by the microprocessor 5. To this aim, a temperature sensor 17 is disposed in contact with the heat reservoir element 15. Preferably, the temperature sensor 17 is located in the part 16 of the heat reservoir element 15 building a part of the outer casing of the user electrical appliance. The temperature sensor 17 is connected to a measuring port of the microprocessor 5.

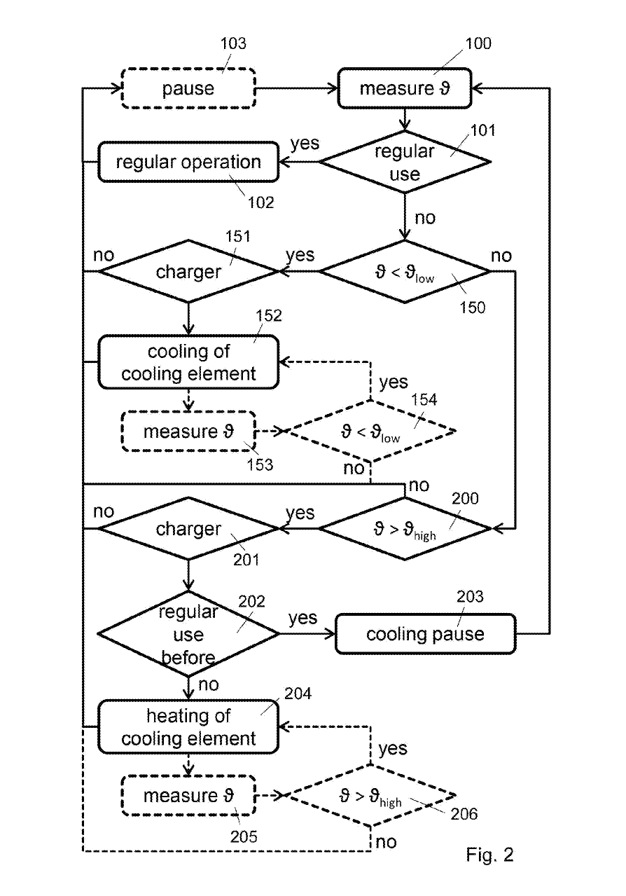

In the following, a preferred embodiment of the proposed method is described with respect to FIG. 2.

The method starts with in step 100 with the measurement of the temperature θ of the heat reservoir element 15 using the temperature sensor 17. In the following step 101 it is checked whether the user electrical appliance 1 is currently in use by the user, i.e. whether regular operation is performed. In this case, the regular operation 102 is continued until the user stops it. Then the method returns to a new measurement of the temperature θ (step 100). Before actually measuring again the temperature θ, it is possible to optionally introduce a pause 103 in order to perform the method not continuously, but in certain reasonable time intervals. The pause 103 might have a duration of 1 or 2 hours, for example. However, it might be chosen with any other duration according to the type of use of the appliance 1.

This pause 103 might be introduced always before the method execution returns to step 100.

If in step 101 no regular use is detected, the method continues in step 150 with checking whether the measured temperature θ is below a lower threshold θ_{low}. If the temperature θ is below this threshold, in a subsequent step 151 it is determined whether the user electrical appliance 1 (being a battery driven device) is connected to the electric power system, in particular through the charger 4 of the secondary batteries. This is important because the further execution of the proposed method can be quite power consuming. With this check is shall be avoided that the power is drawn from the batteries. Accordingly, if the appliance 1 is not connected to the mains, the method execution is stopped by returning to step 100.

Else, if the appliance 1 is connected to the mains, in the following step 152 the cooling element 1 is cooled further by actuation of the thermo element 13, e.g. a peltier element. During actuation of the thermo element 13 cooling the cold side 12, contemporaneously the warm side 15 and the thermoconductingly connected heat reservoir element 15 are heated up. As this is performed when the appliance is not in regular use, the further cooling of the cooling element 11 is not disturbing; it will be heated fast to ambient temperature again because the parts of the user electrical appliance 1 surrounding the cooling element 11 have ambient temperature and cooling element is preferably of a significantly smaller mass than the heat reservoir element 15. The mass might be in the order between 5% and 30% relating to the mass of the heat reservoir element 15. 40% should preferably not be exceeded. After performing step 152 for a certain time (i.e. a predetermined actuation time of the thermo element 13), the method might return to step 100.

Optionally, instead of returning directly to step 100 after the cooling of the cooling element, in step 153 the actual temperature θ of the heat reservoir element 11 is measured again and directly compared with the lower threshold θ_{low} in step 154. In case the actual temperature θ is still below the threshold θ_{low}, the method continues with step 152 and the cooling of the cooling element 11 in order to further heat the heat reservoir element 15. Else, the heat reservoir element 15 is well tempered and the method returns to step 100. This optionally loop is a feedback control of the temperature θ and leads to a dynamical determination of the actuation time of the thermo element 13.

If in step 150 it turns out, that the temperature θ is above the lower threshold θ_{low}, the method continues with step 200 checking whether the temperature θ is above a higher threshold θ_{high}. If this is the case, in a subsequent step 201 it is determined whether the user electrical appliance 1 (being a battery driven device) is connected to the electric power system. This is identical to step 151. If there is no charger connected, the method continues with step 100.

Else it is determined whether the user electrical appliance 1 was just before the execution of this method in regular use (step 202). This might lead to an enhanced temperature θ of the heat reservoir element 15 due to an regular actuation of the thermo element 13 for cooling the cooling element 11. If such regular use is determined e.g. in the last half hour our before the execution of the method, the execution of the method is halted in step 203 for a cooling pause before continuing directly (preferably without the pause 103) with step 100.

If the user electrical appliance 1 was not in regular use just before the execution of this method, it is continued with step 204 with heating of the cooling element thereby contemporaneously cooling the heat reservoir element 15. This can be easily achieved by the microprocessor 5 reversing polarity of the thermo element 13 before its actuation. After performing step 204 for a certain time (i.e. a predetermined actuation time of the thermo element 13 in reversed polarity), the method might return to step 100.

Optionally, instead of returning directly to step 100 after the cooling of the cooling element, in step 205 the actual temperature θ of the heat reservoir element 11 is measured again and directly compared with the higher threshold θ_{high} in step 206. In case the actual temperature θ is still higher than the threshold θ_{high}, the method continues with step 204 and the heating of the cooling element 11 in order to further cool down the heat reservoir element 15. Else, the heat reservoir element 15 is well tempered and the method returns to step 100. This optionally loop is a feedback control of the temperature θ and leads to a dynamical determination of the actuation time of the thermo element 13.

If in step 200 it turns out that the actual temperature θ is also below the higher threshold θ_{high}, the temperature θ is a temperature corridor between θ_{low} and θ_{high}. This assures effective cooling of the cooling element 11 without the risk of exceeding the maximum cooling temperature. The latter might lead to discomfort and skin irritations of the user's skin.

Accordingly, the proposed method and the user electrical appliance 1 with this method implemented in its internal microprocessor 5, guarantee the ordinary function of the skin cooling. It is in fact a kind of feedback control for the actual temperature θ kept in a setpoint temperature corridor between θ_{low} and θ_{high} without installing a complicated control algorithm.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Method for adjusting the maximum cooling temperature of a cooling element of a user electrical appliance, wherein the cooling element is coming in contact with the users skin during regular use of the electrical appliance and wherein the cooling element is connected to a thermo element having a cold side and a warm side, the cold side of the thermo element being in thermoconducting contact with the cooling element and the warm side of the thermo element being in thermoconducting contact with a heat reservoir element of the user electrical appliance, wherein the method comprising the following steps:
(a) measuring the temperature of the heat reservoir element;
(b) determining whether the measured temperature is below a lower threshold;
(c) cooling the cooling element thereby heating the heat reservoir element if the measured temperature is below the lower threshold.

2. Method according to claim 1, wherein the lower threshold is set to the temperature of the dew point.

3. Method according to claim 1, wherein the method comprises the step of determining whether the measured temperature is above a higher threshold.

4. Method according to claim 3, wherein the method comprises the step of heating the cooling element thereby cooling the heat reservoir element if the measured temperature is above the higher threshold.

5. Method according to claim 4, wherein the method comprises the steps of checking whether the user electrical appliance was in regular use within a certain time period before determining whether the measured temperature is above the higher threshold and waiting for a determined cooling pause before continuing with a subsequent method step if the user appliance was in use within said certain time period.

6. Method according to claim 1, wherein the actuation time of the thermo element for the heating or cooling of the cooling element is determined by a measurement of the temperature of the heat reservoir element.

7. Method according to claim 1, wherein it is additionally checked whether the user electrical appliance is in regular user operation, the method being conducted only if no regular user operation of the user electrical appliance is detected.

8. Method according to claim 1, wherein it is additionally checked whether the user electrical appliance is connected to the electric power system.

9. User electrical appliance having an electrical motor for driving an actuator of the user electrical appliance, a power supply, a cooling element coming in contact with the users skin during regular use of the electrical appliance, said cooling element being connected with a thermo element having a cold side and a warm side, the cold side of the thermo element being in thermoconducting contact with the cooling element and the warm side of the thermo element being in thermoconducting contact with a heat reservoir element of the user electrical appliance, and a microprocessor adapted for controlling the actuation of the motor and the thermo element, wherein the user electrical appliance comprises a temperature sensor in thermoconducting contact with the heat reservoir element and connected to a measuring port of the microcontroller and in that the microcontroller is adapted to perform the method according to claim 1.

10. User electrical appliance according to claim 9, wherein the power supply is built by secondary batteries and in that the user electrical appliance comprises a charging device for connecting the secondary batteries to the electric power system.

11. User electrical appliance according to claim 9, wherein the user electrical appliance is a hair removal device.

12. User electrical appliance according to claim 11, wherein the cooling element is integrated into a smear head or pluck roller of the hair removal device.

13. User electrical appliance according to claim 9, wherein the heat reservoir element is integrated in the casing of the hair removal device, the heat reservoir element building a least a part of the outer casing.

14. User electrical appliance according to claim 13, wherein the temperature sensor is located in a position of the heat reservoir element where the heat reservoir element builds the outer casing.
